(19) United States
(12) Patent Application Publication
(10) Pub. No.: US 2002/0149698 A1
(43) Pub. Date: Oct. 17, 2002

(54) Scoreboard tied to players

(76) Inventor: Raymond E. Bowden, Emmett, ID (US)

Correspondence Address: Raymond E. Bowden, 1940 W. Idaho Blvd., Emmett, ID, 83617, US

(21) Appl. No.: 09/835,968

(22) Filed: Apr. 17, 2001

(51) Int. Cl. H04N 5/45; H04N 5/445

(52) U.S. Cl. 348/565; 348/566

(57) ABSTRACT

This is a patent application for a method of color presentation on the split-screen, mini-scoreboard portion of televised sporting events which will readily allow viewers to relate the teams listed on the scoreboard directly to the players on the field, court, or rink. The invention is entitled “Scoreboard Tied to Players.” It is submitted by Raymond E. Bowden, 1940 W. Idaho Blvd., Emmett, Idaho 83617.

Televised team sports events regularly have a small screen within the full screen that generally displays the score and other information like the period of play, the time remaining, or the inning in play, etc. When tuning in to a contest in progress, or while surfing channels between two or more events, it is extremely difficult to relate the score on the small screen to the teams on the field, or court, or rink. My invention provides a means of immediately relating the score presented on the small screen to each of the teams on the field.

### DESCRIPTION

An object of the present invention is to provide a means for television viewers of sporting events to immediately relate the score of a game presented on a small portion of a split television screen, to the teams on the field, when they tune in on a game in progress.

A second object is to provide a means for fans to quickly relate each team or player to statistics often presented during or at the end of various sports games.

### BACKGROUND

To a sports fan, it can be very frustrating to tune in to a sporting event in process, see the score and other information on a small portion of the screen, and not be able to relate the score to one team or the other on the playing area, often for extended periods of time. This is particularly true of fans who don't know each team's colors, which may change from season to season or while playing at home or away. The large number of professional teams in play, with an even greater number of college teams, makes it difficult to identify a team until a camera close-up clearly displays a team name or logo. (Major league baseball—30 teams, National Football League—31, National Basketball Association—29, National Hockey League—30).

During televised sporting events including baseball, football, basketball, hockey, soccer-ball and others, a small part of the television screen shows a mini-screen independent of the main picture. The smaller picture is typically around 5″ wide and 3″ to 5″ high on a 27″ television screen, depending on the amount of information presented. The smaller picture is typically displayed in the upper left-hand corner of the screen or the lower right-hand corner of the screen. Typically, the mini-picture displays an abbreviated name for each team, the score of each team at that moment, and the time remaining in each period of play or in the game, for time controlled sports such as basketball, football, hockey and soccer ball. The mini-picture may also present the name of the television network, and, for example, the inning of play and a graphic of base runners for baseball; the down being played, distances for first downs, and a flag, if thrown, for football; the quarter of play and other information for basketball, etc. Typically, the mini-picture is on display for an estimated 75% or more of the time the contest is in progress.

In all cases regarding the abbreviated names of each of the teams in the contest and the background color they are presented on, the names of both teams typically are currently and historically presented in the same color and the background for both teams is presented in a contrasting color. Overall, the mini-screen picture utilizes a spectrum of colors in presenting the various bits of information, and there is no relationship between the background or foreground colors on the mini-screen scoreboard and the colors of uniforms worn by players on the playing field.

With the exception of baseball, where the distinction is not always totally clear, the jersey, or upper part of players' uniforms, almost always are of distinctly different colors. The purpose of this is obvious—the colors identify teammates to each other as well as making it easier for observers (fans) to follow the action. For example, if two competing football teams wore white jerseys, a quarterback running for his life would be unable to identify his receiver from the other team's defenders.

During sporting events presented on television, it is common for the presenting network to provide comparative statistics of teams or featured players. Often, by the time a fan finds the descriptive column heads and tries to figure out which team the statistics relate to, the statistical comparison disappears from the screen, and become relatively meaningless.

Major television networks and cable television broadcasters often run short clips of previously televised games during daily news reports and in sports shows. These short clips commonly include a portion of the contest that included the mini-screen scoreboard and the score. With no means of relating the scoreboard to the teams on the playing field, the major point of the “clip” presentation is often lost.

The state of the art for color presentations on television screens is such that, as it relates to scoreboards and split (or mini) screens, each section of a mini-screen scoreboard can be presented in a large variety of colors, and the print and figures on those scoreboards can readily be presented in a large variety of colors. This capability is readily available on home personal computers, for example, with regular Microsoft software.

### SUMMARY OF THE INVENTION

First:

My invention relates to the mini-screen portion of televised sporting events which list the abbreviated names of the two teams involved in the contest, and other data. On the mini-screen scoreboard, the background color behind each team name will be presented in the color of that team's jersey (or any other name for the upper part of the uniform covering the human torso), and the lettering will be of a contrasting color. A fan tuning in to a game in progress can immediately relate the score on the mini-screen to each of the teams on the field.

Second:

My invention covers the possibility of the reverse of the above, whereby the lettering of the team name would be of the same color as the jerseys, and the background coloring would be contrasting, but random.

Third:

The mini-screen or the major screen sometimes presents team or player statistics, or comparisons of player or team statistics for each of the teams. The “Scoreboard Tied to Players” system can also be applied here. By utilizing team jersey (or whatever uniform part is utilized) colors as the background color for statistical presentations, a viewer could quickly relate to the presentation because they would not have to follow column headings which identify each team.

Fourth:

A banner (2″-3″ high and almost screen width on a 27″ screen) is periodically displayed at the bottom of the screen during sporting events which prints out the full name of the team and the score in large letters and figures. The “Scoreboard Tied to Player” coloring system, whereby the jersey color of the teams involved would serve as a background color for each team, could also be utilized in this area for quick fan identification of each team.

Fifth:

Televised sports contests are often replayed on the sports section of regular news telecasts and on sports shows. Whenever and wherever the games are replayed, the mini-screen presenting the score, time left, etc. appears in the same manner as during the original broadcast. By using the “Scoreboard Tied to Players” coloring system during original broadcasts, viewers will quickly be able to identify the teams even during a short replay session.

Sixth:

The term “jersey” is used universally to identify the part of the players' uniforms that cover the upper part of the human body, or torso.

Seventh:

Application of the “Scoreboard Tied to Players” system relates to male and female players equally.

### BRIEF DESCRIPTION OF THE DRAWINGS

FIG. 1. Illustrates the portion of a televised split screen mini-screen scoreboard on which the team names, score, period of play, and time remaining, is presented. The drawing shows the mini-screen scoreboard of a Denver-Oakland National Football League game in the 4th period, where-in the jerseys of the Denver team were blue, and the background color behind “DEN” on the mini-scoreboard is also blue. The jerseys of the Oakland team were white, and the background color behind “OAK” on the mini-scoreboard is also white.

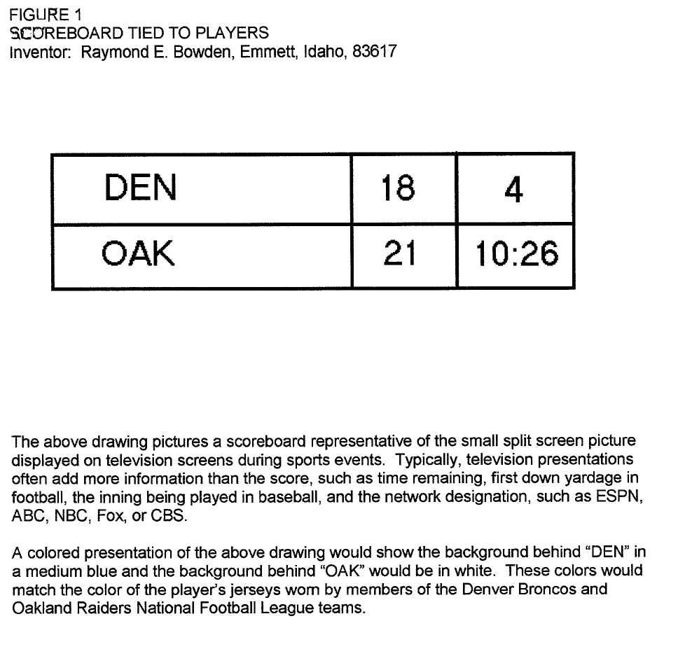

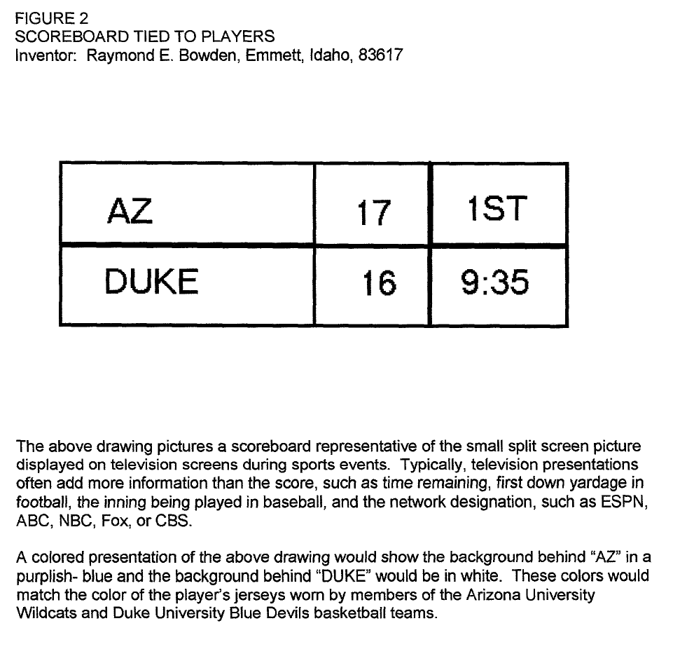

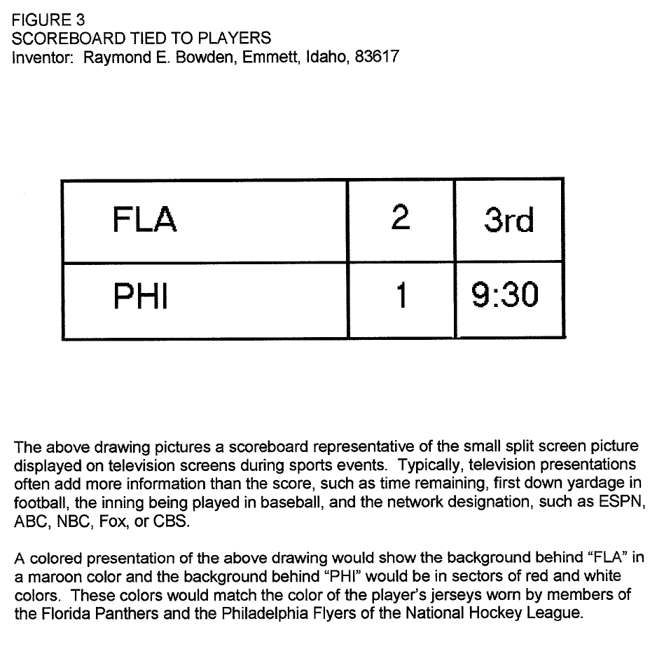

The background color of the score, the quarter, and the time left to play is white in the above drawing. However, the team color could continue across the figures sections, or some other color than team colors could be used, so long as the score and other figures are in a contrasting color and easily legible.

A person tuning in on an in-progress game can immediately tell from the mini-screen that Oakland is leading Denver by a score of 21 to 18, that it is the fourth quarter with 10 minutes and 26 seconds remaining in the game, and the team on the field with the blue jerseys is the Denver team and the team on the field with the white jerseys is the Oakland team.

FIG. 2. Illustrates the portion of a televised split screen mini-screen scoreboard on which the team names, score, period of play, and time remaining, is presented. The drawing shows the mini-screen scoreboard of the year 2001 NCAA basketball finals, involving the Arizona Wildcats and the Duke Blue Devils. The game is in the first quarter, the jerseys of the Arizona team were purplish-blue, and the background color behind “AZ” on the mini-scoreboard is also purplish-blue. The jerseys of the Duke team were white, and the background color behind “DUKE” is also white.

The background color of the score can be the same as the team color. The period of play and time left to play can be in any combination of colors available so long as the score and other figures are in a contrasting color and easily legible.

A person tuning in on an in-progress game can immediately tell from the mini-screen that Arizona is leading Duke by a score of 17 to 16, that it is the first half, with 9 minutes and 35 seconds remaining in the first half, and the team on the basketball court with the purplish-blue jerseys is the Arizona team and the team on the basketball court with the white jerseys is the Duke team.

FIG. 3. Illustrates the portion of a televised split screen mini-screen scoreboard on which the team names, score, period of play, and time remaining, is presented. The drawing shows the mini-screen scoreboard of a National Hockey League game involving the Florida Panthers and the Philadelphia Flyers. The game is in the third period, the jerseys of the Florida team were maroon, and the background color behind “FLA” on the mini-scoreboard is also maroon. The jerseys of the Philadelphia team were red and white, and the background color behind “PHI” is also red and white.

Typically, television presentations of the score mini-screen often add more information than the score, such as time remaining, first down yardage in football, the inning being played in baseball, and the network designation, such as ESPN, ABC, NBC, Fox, or CBS.

The background color of the score column and period of play can be of the same colors as the team jerseys or any other combination of contrasting colors.

A person tuning in on an in-progress game can immediately tell from the mini-screen that Florida is leading Philadelphia by a score of 2 to 1; that the game is in the 3^{rd} period, there are 9 minutes and 30 seconds remaining; that the team on the hockey rink with the maroon jerseys is the Florida team and the team on the hockey rink with the red and white jerseys is the Philadelphia team.

### EXAMPLE OF UTILIZATION

### Example 1

Sports fan tunes in on a televised basketball game in progress. He sees the mini-screen presentation of the score, but cannot determine which team is which. With the “Scoreboard Tied to Players” system in play, he notes the color of the background of one of the teams on the mini-screen scoreboard and immediately relates it to one of the teams on the floor. Now he knows whether to hope a shot goes in or stays out and can immediately enjoy the action.

### Example 2

Sports fan is watching college football, and is especially interested in three games being televised at the same time. In the process of surfing between the three games, with four of the six teams dressed in different colors, he has been unable to keep track of who is who on the field. With the “Scoreboard Tied to Players” system in play, he can quickly identify the teams on the playing field at any time the mini-scoreboard is on the screen.

### Example 3

Sports fan is watching a basketball game and during a time out, the television network presents a statistical comparison of the output of comparative players from each team. By the time the fan has figured out which column of figures relates to which player, the statistical comparison is removed from the screen. With the “Scoreboard Tied to Players” system in play, he can automatically and quickly relate the statistics to the player/team, and get the benefit from the presentation that is intended.

What is claimed is:

1. A method of immediately relating live sports event scores presented on television mini-screens (split screens) to each of the teams on the field, court or rink of play by utilizing team jersey* colors as a background color to the name of each team on the televised mini-screen scoreboard. Team names would be printed in contrasting colors. (*Or a player's uniform part by any other name, covering the upper human torso).

2. A method of immediately relating live sports event scores presented on television mini-screens (split screens) to each of the teams on the field, court, or rink of play by printing the team name on the televised mini-screen scoreboard with the same color as the jerseys* of the players on the field, court or rink of play. The background behind the team name would be of a contrasting color. (*Or a player's uniform part by any other name, covering the upper human torso).

3. A method of immediately relating live sports event scores presented on television mini-screens (split screens) to each of the teams on the field, court, or rink of play by coloring the background of the scores the same color as player jerseys* of each team. The colors of printed team names and background would be of some color other than the colors of team players' jerseys.* (*Or a player's uniform part by any other name, covering the upper human torso).

4. A method of immediately relating live sports event scores presented on television mini-screens (split screens), to each of the teams on the field, court, or rink of play by coloring the numbers of the scores the same color as player jerseys* of each team. The colors of the background behind the scores and printed team names and background would be of some color other than the colors of team players' jerseys.* (*Or a uniform part by any other name, covering the upper human torso).

5. A method of immediately relating live sports event scores presented on television mini-screens (split screens) to each of the teams on the field, court, or rink of play by relating the color of player headgear (e.g. football helmets, baseball caps) to any or all portions of the televised mini-screen scoreboard.

6. A method of immediately relating live sports event scores presented on television mini-screens (split screens) to each of the teams on the field, court, or rink of play by relating the color of the part of the uniform covering the body area below the waist, otherwise known as pants, trousers, sweats, shorts and other names.

7. A method of immediately relating live sports event scores presented on television mini-screens (split screens) to each of the teams on the field, court, or rink of play by relating the color of any selected part of players' uniforms to any part of the televised mini-screen scoreboard.

8. Claims 1-7 will apply to televised sports events in professional baseball, professional football, professional basketball, professional hockey, professional soccer, college basketball and football, and to Olympic sports events where applicable.
